(19) United States
(12) Patent Application Publication
(10) Pub. No.: US 2025/0192355 A1
(43) Pub. Date: Jun. 12, 2025

(54) BATTERY PACK

(71) Applicants: Hyundai Motor Company, Seoul (KR); Kia Corporation, Seoul (KR)

(72) Inventors: In Gook Son, Hwaseong-si (KR); Hyun Chang Kang, Hwaseong-si (KR); Young Hoo Oh, Hwaseong-si (KR); Yu Ri Oh, Hwaseong-si (KR); Seok Eun Yoon, Hwaseong-si (KR)

(21) Appl. No.: 18/922,992

(22) Filed: Oct. 22, 2024

(30) Foreign Application Priority Data
Dec. 12, 2023 (KR) 10-2023-0180165

(51) Int. Cl. H01M 50/358; H01M 50/209; H01M 50/271; H01M 50/30

(52) U.S. Cl. CPC H01M 50/358; H01M 50/209; H01M 50/271; H01M 50/394

(57) ABSTRACT

An embodiment battery pack includes a battery module and a battery pack housing covering the battery module, the battery pack housing including a venting frame disposed on an upper side of the battery module and including a venting hole configured to discharge a fluid generated in the battery module and a pack cover disposed on an upper side of the venting frame and communicated with the venting hole to include a venting passage extending horizontally together with the venting frame.

### CROSS-REFERENCE TO RELATED APPLICATIONS

This application claims the benefit of Korean Patent Application No. 10-2023-0180165, filed on Dec. 12, 2023, which application is hereby incorporated herein by reference.

### TECHNICAL FIELD

The present disclosure relates to a battery pack.

### BACKGROUND

Recently, as awareness of the crisis over the environment and depletion of oil resources has increased, research and development on electric vehicles that are eco-friendly vehicles, has been highlighted. Electric vehicles include plug-in hybrid electric vehicles (PHEVs), battery electric vehicles (BEVs), and fuel cell electric vehicle (FCEVs).

An electric vehicle may include a battery module and a battery pack housing that supports the battery module. Meanwhile, the electric vehicle uses battery cells in the battery module as a power source, and when a fire occurs in the battery module, there is a risk of a thermal runaway occurring.

Meanwhile, a need exists for an electric vehicle that prevents a thermal runaway that may occur in the battery pack and reduces heat transfer between battery cells when a fire occurs in a battery module of the electric vehicle.

### SUMMARY

Embodiments of the present disclosure can solve problems occurring in the prior art while advantages achieved by the prior art are maintained intact.

An embodiment of the present disclosure provides a battery pack that may guide fluid generated in a battery module to an outside of a battery pack.

The technical problems solvable by embodiments of the present disclosure are not limited to the aforementioned problems, and any other technical problems not mentioned herein will be clearly understood from the following description by those skilled in the art to which the present disclosure pertains.

According to an embodiment of the present disclosure, a battery pack includes a battery module and a battery pack housing covering the battery module. The battery pack housing includes a venting frame disposed on an upper side of the battery module, a venting hole that discharges a fluid generated in the battery module, and a pack cover disposed on an upper side of the venting frame and communicated with the venting hole to include a venting passage extending horizontally together with the venting frame.

The venting hole may be provided in plural and the venting holes may be spaced apart in a first direction being a lengthwise direction of the venting frame and a second direction being a vertical direction, the venting frame may include a venting connector provided between the venting holes, and the pack cover may include a cover coupling part disposed on an upper side of the venting connector and coupled to the venting connector.

The pack cover may include a cover guide part disposed on an upper side of the venting hole and extending in the first direction to guide the fluid in the first direction through the venting passage.

The cover coupling part may protrude downward toward the venting connector farther than the cover guide part.

The battery module may be provided in plural and the battery modules may be spaced apart from each other in the second direction, and when viewed from a top view, the venting connector and the cover coupling part may be disposed between two adjacent battery modules.

The battery module may include a plurality of battery cells, a module guide frame disposed on an upper side of the battery cells and including a guide hole that guides the fluid generated in any one battery cell of the battery cells to an upper side of the battery module, and a module cover disposed on a side of the module guide frame in an upward/downward direction. The module cover may include a notch part disposed in an area facing the guide hole or that surrounds the area facing the guide hole to have a relatively small thickness.

The module cover may include a cover part disposed on the side of the module guide frame in the upward/downward direction and covering the upper side of the battery cells and a separation part disposed in the area facing the guide hole and separated from the cover part by a pressure of the fluid generated in the any one of the battery cells. The notch part may be disposed along a circumference of the separation part.

The notch part may include a first notch part arranged along a first direction of the module cover and a second notch part arranged along a second direction of the module cover crossing the first direction and crossing the first notch part in an intermediate area of the first notch part.

According to an embodiment of the present disclosure, a battery pack includes a battery module and a battery pack housing covering the battery module. The battery pack housing may include a venting frame disposed on an upper side of the battery module and including a venting hole configured to discharge a fluid generated in the battery module and a pack cover disposed on an upper side of the venting frame and communicated with the venting hole to include a venting passage extending horizontally together with the venting frame and a base plate that supports the battery module and a side member supported by the base plate and extending along a circumference of the base plate. The side member may define a discharge hole communicated with the venting passage.

The discharge hole may be disposed adjacent to one end portion of the battery pack housing in a lengthwise direction thereof.

The venting frame may include a communication hole communicating the venting passage and the discharge hole.

The communication hole may be disposed adjacent to the discharge hole on an upper side of the discharge hole.

The battery pack may further include a mesh member disposed in the communication hole or the discharge hole.

The communication hole may be disposed in a first area that is both one end portion of the venting frame in a first direction, which is a lengthwise direction thereof and one end portion of the venting frame in a second direction, which is a perpendicular direction to the first direction.

The venting frame may further include a venting cover part disposed in a second area that is both the one end portion of the venting frame in the first direction and an opposite end portion of the venting frame in the second direction, and the venting cover part dividing an upper area and a lower area of the venting frame.

According to an embodiment of the present disclosure, a battery pack includes a battery module including a plurality of battery cells, a module guide frame disposed on the battery cells and including a guide hole guiding a fluid generated from any one of the battery cells to an upper side of the battery module, and a module cover disposed on a side of the module guide frame in an upward/downward direction. The module cover may include a perforated part disposed in an area facing the guide hole or disposed along a periphery of the area facing the guide hole and a battery pack housing covering the battery module. The battery pack housing may include a venting frame disposed on the upper side of the battery module and including a venting hole configured to discharge the fluid generated in the battery module and a pack cover disposed on an upper side of the venting frame and communicated with the venting hole to include a venting passage extending horizontally together with the venting frame.

The module cover may include a cover part covering an upper side of the battery cells and a separation part disposed in the area facing the guide hole and separated from the cover part by a pressure of the fluid generated in the any one battery cells.

The perforated part may be disposed along a circumference of the separation part.

The perforated part may include a first perforated part and a second perforated part spaced apart from the first perforated part.

The perforated part may include a first perforated part arranged along a first direction of the module cover and a second perforated part arranged along a second direction of the module cover crossing the first direction and crossing the first perforated part in an intermediate area of the first perforated part.

### BRIEF DESCRIPTION OF THE DRAWINGS

The above and other objects, features, and advantages of embodiments of the present disclosure will be more apparent from the following detailed description taken in conjunction with the accompanying drawings, in which:

FIG. 1 is a perspective view of a battery pack according to an embodiment of the present disclosure;

FIG. 2 is an exploded perspective view of a battery pack according to an embodiment of the present disclosure;

FIG. 3 is an exploded perspective view of a venting frame and a pack cover according to an embodiment of the present disclosure;

FIG. 4 is a perspective view of a battery module, from which a module cover is separated, according to an embodiment of the present disclosure;

FIG. 5 is a vertical cross-sectional view of a battery module according to an embodiment of the present disclosure;

FIG. 6 is a longitudinal cross-sectional view of a battery module according to another embodiment of the present disclosure;

FIG. 7 is a schematic view of a module cover having a perforated part according to an embodiment of the present disclosure;

FIG. 8 is a schematic view of a module cover having a perforated part according to another embodiment of the present disclosure;

FIG. 9 is a schematic view of a module cover having a perforated part according to another embodiment of the present disclosure;

FIG. 10 is a schematic view of a module cover having a perforated part formed according to another embodiment of the present disclosure;

FIG. 11 is a schematic view of a module cover having a notch part formed according to another embodiment of the present disclosure;

FIG. 12 is a longitudinal cross-sectional view of a battery pack according to an embodiment of the present disclosure;

FIG. 13 is a schematic view illustrating a flow of a fluid vented through a venting passage according to an embodiment of the present disclosure; and

FIG. 14 is a schematic view illustrating a flow of a fluid discharged to an outside of a battery pack through a communication hole and a discharge hole according to an embodiment of the present disclosure.

### DETAILED DESCRIPTION OF ILLUSTRATIVE EMBODIMENTS

Hereinafter, some embodiments of the present disclosure will be described in detail with reference to the attached drawings so that those skilled in the art may easily implement the present disclosure. When adding reference numerals to components in each drawing, it should be noted that identical components are given the same reference numerals as much as possible even if they are shown in different drawings. Additionally, in describing embodiments of the present invention, when it is determined that detailed descriptions of related known configurations or functions may impede understanding of the embodiments of the present invention, detailed descriptions thereof will be omitted.

Furthermore, in describing the components of the embodiments of the present disclosure, terms such as first, second, “A”, “B”, (a), and (b) may be used. The terms are simply for distinguishing the components, and the essence, the sequence, and the order of the corresponding components are not limited by the terms. Unless defined differently, all the terms including technical or scientific terms have the same meanings as those generally understood by an ordinary person in the art to which the present disclosure pertains. The terms, such as the terms defined in dictionaries, which are generally used, should be construed to coincide with the context meanings of the related technologies, and are not construed as ideal or excessively formal meanings unless explicitly defined in the present disclosure.

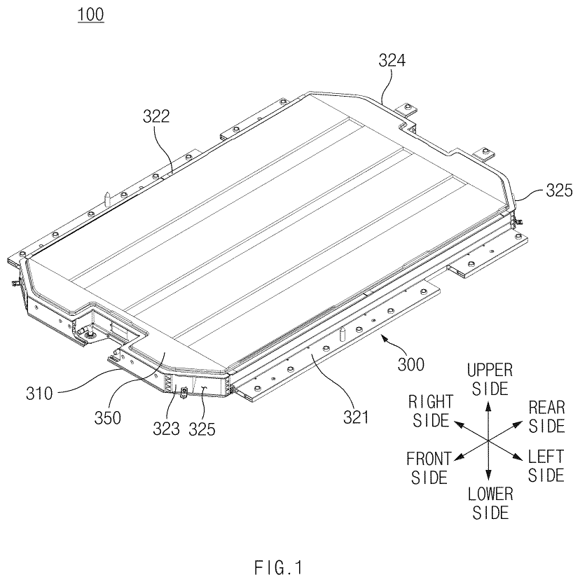

Hereinafter, embodiments of the present disclosure will be described in detail with reference to FIGS. 1 to 14.

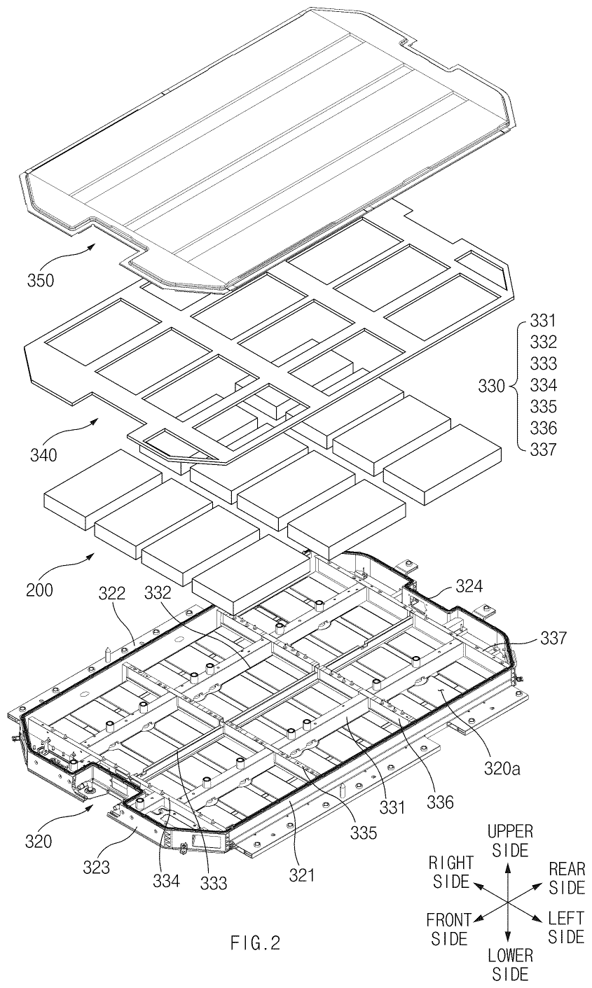

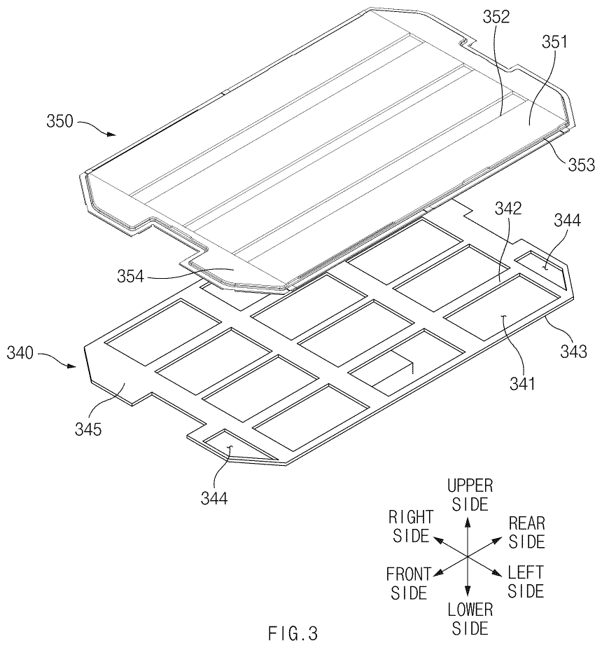

FIG. 1 is a perspective view of a battery pack according to an embodiment of the present disclosure. FIG. 2 is an exploded perspective view of the battery pack according to an embodiment of the present disclosure. FIG. 3 is an exploded perspective view of a venting frame and a pack cover according to an embodiment of the present disclosure.

Referring to FIGS. 1 to 3, a battery pack 100 may be a component that is mounted in an interior of an electric vehicle to transmit power to the electric vehicle. The battery pack 100 may include a battery module 200 and a battery pack housing 300 that covers the battery module 200.

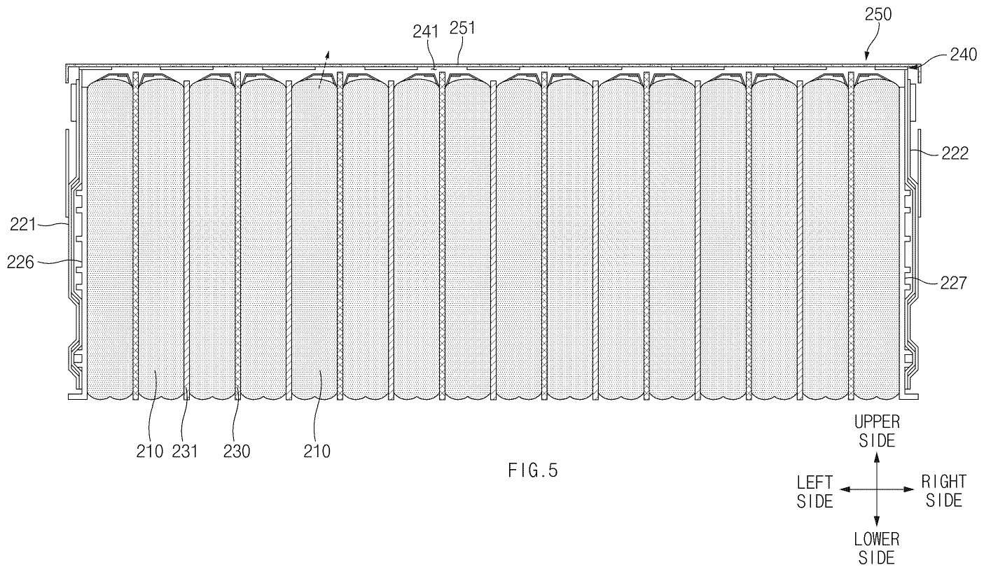

The battery module 200 may include a plurality of battery cells 210 (see FIG. 5). The battery cells 210 may be lithium-ion batteries, but they are not limited thereto. The plurality of battery cells 210 may be used in the form of the battery module 200 to be protected from an external shock, heat, vibration, or the like. The plurality of battery modules 200 may be supported by the battery pack housing 300 while being spaced apart from each other in a forward/rearward direction or a leftward/rightward direction.

The battery pack housing 300 may include a base plate 310 that is disposed on a lower side of the battery module 200 and supports the battery module 200 and a side member 320 that is supported by the base plate 310 and extends along a circumference of the base plate 310. The battery pack housing 300 may include a pack cover 350 that is coupled to the side member 320 and covers an upper side of the battery module 200.

The base plate 310 may be formed to have a substantially rectangular shape such that a forward/rearward direction becomes a lengthwise direction thereof. The side member 320 may be coupled to the base plate 310 along the circumference of the base plate 310 to cover a front side, a rear side, a left side, and a right side of the battery module 200.

The side member 320 may include a first side member 321 that extends in a first direction that faces a front side to cover the left side of the battery module 200 and a second side member 322 that is provided in parallel to the first side member 321 to cover the right side of the battery module 200. The side member 320 may include a third side member 323 that connects the first side member 321 and the second side member 322 and covers the front side of the battery module 200 and a fourth side member 324 that is provided in parallel to the third side member 323 and covers the rear side of the battery module 200.

Meanwhile, the side member 320 may define a discharge hole 325 for discharging fluid generated in the battery module 200 to an outside of the battery pack 100. The discharge hole 325 may be formed in each of the third side member 323 and the fourth side member 324. Unlike this, the discharge hole 325 may be formed between the first side member 321 and the third side member 323 or between the first side member 321 and the fourth side member 324. A module accommodating part 320a may be defined between the first to fourth side members 321, 322, 323, and 324. The module accommodating part 320a may be a space for accommodating the plurality of battery modules 200. The module accommodating part 320a may be divided by a division member 330 to accommodate the battery modules 200.

The division member 330 may include longitudinal members 331, 332, and 333 that are configured to divide the module accommodating part 320a in a second direction (e.g., a rightward direction) that is perpendicular to a first direction (e.g., a forward direction) and transverse members 334, 335, 336, and 337 that are configured to divide the module accommodating part 320a in the first direction.

The longitudinal members 331, 332, and 333 may include a first longitudinal member 331 that is located on a left side of the base plate 310, a second longitudinal member 332 that is provided in parallel to the first longitudinal member 331 and is located on a right side of the base plate 310, and a third longitudinal member 333 that is provided between the first longitudinal member 331 and the second longitudinal member 332.

The transverse members 334, 335, 336, and 337 may include a front transverse member 334 that is disposed adjacent to the third side member 323 and a rear transverse member 337 that is provided in parallel to the front transverse member 334 and is disposed adjacent to the fourth side member 324. The transverse members 334, 335, 336, and 337 may include a first middle transverse member 335 and a second middle transverse member 336 that are provided between the front transverse member 334 and the rear transverse member 337.

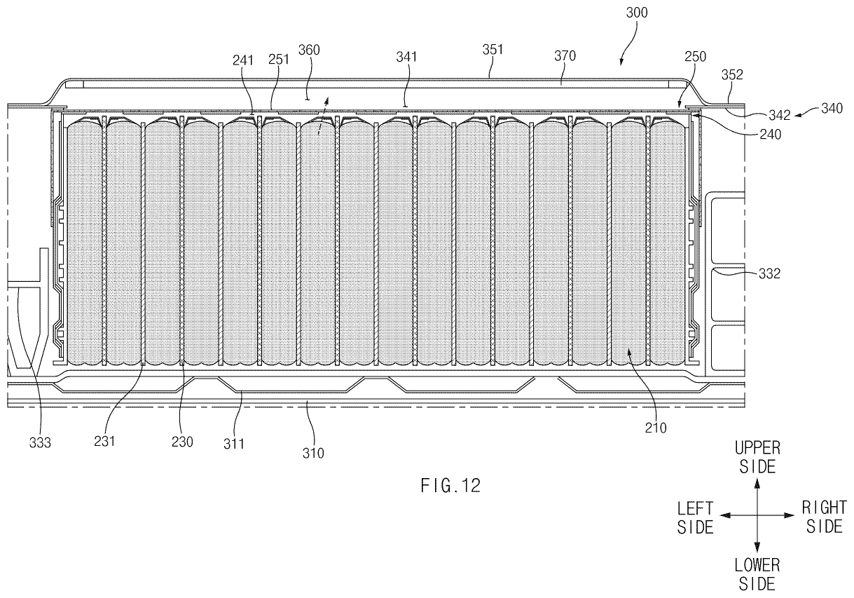

Meanwhile, the battery pack housing 300 may include a venting frame 340 that is disposed on an upper side of the battery module 200 to define a venting hole 341, through which the fluid generated in the battery module is discharged, and the pack cover 350 that is disposed on an upper side of the venting frame 340 and is communicated with the venting hole 341 to define a venting passage 360 (see FIG. 12) that extends horizontally together with the venting frame 340.

The venting frame 340 may define a plurality of venting holes 341. A plurality of venting holes 341 may be provided to correspond to a position of the battery module 200. The plurality of venting holes 341 may be configured to be spaced apart in the first direction (e.g., the forward direction) that is the longitudinal direction of the venting frame 340 and the second direction (e.g., the rightward direction).

The venting frame 340 may include a venting connector 342 that extends in the first direction between adjacent ones of the plurality of venting holes 341, which are spaced apart from each other in the second direction, and a venting circumferential part 343 that is located on opposite sides of the venting frame 340, which are sides in the second direction and an opposite direction to the second direction, and extends in the first direction. The venting connector 342 may be provided in parallel to the venting circumferential part 343. The venting connector 342 and the venting circumferential part 343 may be integrally formed, and the venting connector 342 and the venting circumferential part 343 may gather to define a body area of the venting frame 340.

The venting frame 340 may be disposed to correspond to an extension direction of the side member 320 to cover an upper side of the module accommodating part 320a defined by the side member 320.

The venting frame 340 may include communication holes 344 provided at opposite ends thereof in the first direction (e.g., the forward direction). In more detail, the pair of communication holes 344 may be formed in areas that are opposite ends of the venting frame 340 in the first direction and also are one end portion of the venting frame 340 in the second direction.

The venting frame 340 may include venting cover parts 345 that are formed in areas that are opposite ends thereof in the first direction and also are opposite end portions in the second direction. The venting cover part 345 may divide an upper area and a lower area of the venting frame 340. An electrical module (not illustrated) provided on a front side of the side member 320 or a rear side of the side member 320 may be provided in a lower area of the venting cover part 345, and the venting cover part 345 may cover an upper side of the electrical module. That is, the venting cover part 345 may function to protect the electrical module.

As illustrated in the figure, the communication hole 344 may be provided on a front side and a rear side of the venting frame 340 and may also be formed in an area on the left side, and the venting cover part 345 may be provided on the front side and the rear side of the venting frame 340 and may also be formed in an area on the right side, but embodiments of the present disclosure are not limited thereto.

Unlike the illustration of the drawings, the communication hole 344 may be provided on the front side and the rear side of the venting frame 340 and may also be formed in an area on the right side, and the venting cover part 345 may be provided on the front side and the rear side of the venting frame 340 and may also be formed in an area on the left side. In this structure, the discharge hole 325 may be provided on the front side and the rear side of the battery pack 100 and may also be provided in an area on the left side.

The pack cover 350 may include a cover guide part 351 that is provided on an upper side of the venting hole 341 to cover the venting hole 341 and a cover coupling part 352 that is provided on an upper side of the venting connector 342 to cover the venting connector 342. The pack cover 350 may include a cover circumferential part 353 that is provided on an upper side of the venting circumferential part 343.

The cover guide part 351 may extend in the first direction that is a lengthwise direction of the pack cover 350 to guide the fluid in the first direction (e.g., the forward direction) or an opposite direction to the first direction (e.g., the rearward direction) through the venting passage 360. A plurality of cover guide parts 351 may be provided to be spaced apart from each other along the second direction (e.g., the rightward direction). The cover coupling part 352 may be provided between two adjacent ones of the plurality of cover guide parts 351.

The cover coupling part 352 may be disposed on an upper side of the venting connector 342 and may be coupled to the venting connector 342. The cover coupling part 352 may protrude downward toward the venting connector 342 farther than the cover guide part 351 to be coupled to the venting connector 342. The cover coupling part 352 may also extend in the first direction between adjacent cover guide parts 351.

The cover circumferential part 353 may be provided on a side of the pack cover 350 in the second direction (e.g., the rightward direction) and an opposite direction (e.g., the leftward direction) to the second direction, and the cover circumferential part 353 may extend in the first direction (e.g., the forward direction). The cover circumferential part 353 may be disposed on an upper side of the venting circumferential part 343 and may be coupled to the venting circumferential part 343.

According to the above-described structure, the venting frame 340 and the pack cover 350 may be coupled to each other, and accordingly, the venting frame 340 may be fixed on an upper side of the battery module 200 by the pack cover 350.

The venting connector 342 and the cover coupling part 352 may be fixed by adhesive that is provided between the venting connector 342 and the cover coupling part 352. However, embodiments of the present disclosure are not limited thereto, and the venting connector 342 and the cover coupling part 352 may be welded to each other or coupled to each other by a separate fastening member.

Likewise, the venting circumferential part 343 and the cover circumferential part 353 may be fixed by an adhesive provided between the venting circumferential part 343 and the cover circumferential part 353. However, embodiments of the present disclosure are not limited thereto, and the venting circumferential part 343 and the cover circumferential part 353 may be welded to each other or coupled to each other by a separate fastening member.

The pack cover 350 may include a communication cover part 354 that is provided on an upper side of the communication hole 344 to cover an upper side of the communication hole 344.

Both the venting frame 340 and the pack cover 350 may be formed of steel or stainless steel. When viewed from a top, the venting frame 340 and the pack cover 350 may be disposed between adjacent battery modules 200 among the battery modules 200 spaced apart in the second direction.

The venting hole 341 and the cover guide part 351 may be disposed on an upper side of the battery module 200 to guide the fluid that is generated in the battery module 200 and flows to the upper side of the battery module 200 to opposite ends of the battery pack 100 in the first direction that is the lengthwise direction of the battery pack 100.

Furthermore, the venting connector 342 and the cover coupling part 352 may be coupled to each other between the adjacent ones of the battery modules 200 in the second direction to define opposite side parts of the venting passage 360 in the second direction.

According to the structure, a high temperature gas generated in the battery module 200 may flow to the upper side of the battery module 200 and may be discharged to an outside of the battery pack 100 while the high temperature gas is not introduced into other adjacent battery modules 200. Accordingly, the battery pack 100 may prevent a thermal runaway between the battery modules 200, and thus, safety may be improved.

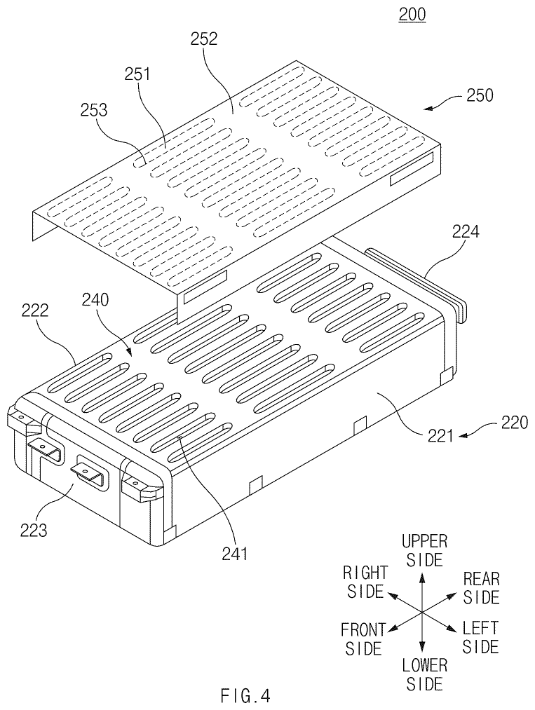

FIG. 4 is a perspective view of the battery module, from which the module cover is separated, according to an embodiment of the present disclosure. FIG. 5 is a vertical cross-sectional view of the battery module according to an embodiment of the present disclosure.

Referring to FIGS. 4 and 5, the battery module 200 may have a structure for preventing a thermal runaway and a thermal transfer between the battery cells 210 in the interior of the battery module 200 separately from the venting passage 360 of the above-described battery pack 100 (see FIG. 1).

The battery module 200 may include a module housing 220 that covers the battery cells 210 stacked in the second direction (e.g., the rightward direction). The module housing 220 may include a first side frame 221 that covers a left side of a battery cell 210, a second side frame 222 that covers a right side of the battery cells 210, and a third side frame 223 and a fourth side frame 224 that cover a front side and a rear side of the battery cells 210, respectively.

The module housing 220 may include a module guide frame 240 that is provided on the upper side of the battery cells 210 to define a guide hole 241 that is configured to guide the high temperature gas generated in the battery cells 210 to the upper side of the battery module 200.

A plurality of guide holes 241 may be provided and may be arranged in the first direction (e.g., the forward direction) that is a direction in which the battery cells 210 extend and a second direction (e.g., the rightward direction) that is perpendicular to the first direction. The guide hole 241 may be formed between two adjacent battery cells 210 and may function as a passage through which the high temperature gas generated from the two adjacent battery cells 210 is discharged.

The module housing 220 may include a module cover 250 that is disposed on an upper side of the module guide frame 240. The module cover 250 may include a perforated part 253 that is formed along a periphery of an area that faces the guide hole 241.

The module cover 250 may include a cover part 252 that is disposed on the upper side of the module guide frame 240 and covers an upper side of the battery cells 210 and a separation part 251 that is formed in an area that faces the guide hole 241 and is configured to be separated from the cover part 252 by the high temperature gas pressure generated in the battery cells 210.

In other words, the separation part 251 may be provided on an upper side of the guide hole 241 to cover the upper side of the guide hole 241, and then, it may be separated from the cover part 252 due to the high temperature gas pressure generated in the battery cells 210.

According to the structure, foreign substances may be prevented from being introduced into the battery cell 210 when the battery cell 210 is operated normally, and at the same time, the high temperature gas caused by a fire may be discharged to an outside of the battery cells 210 when the fire occurs in the battery cells 210. In particular, when the high temperature gas in a battery cell 210, in which a fire occurs, flows to another battery cell 210 that is adjacent thereto, a fire may also occur in the adjacent battery cell 210, and thus, this may be prevented from occurring and a thermal runaway that may occur in the plurality of battery cells 210 may also be prevented.

When viewed in the first direction (e.g., the forward direction), a first blocking member 230 may be provided between adjacent battery cells 210 to delay heat transfer between the battery cells 210. The first blocking member 230 may delay heat transfer between the battery cells 210 that face each other while the first blocking member 230 is interposed therebetween. To achieve this structure, the first blocking member 230 may be formed of a fire-resistant material. Furthermore, the first blocking member 230 may press the plurality of battery cells 210 that are arranged in the second direction when the plurality of battery cells 210 are swollen.

A plurality of first blocking members 230 may be provided to be spaced apart from each other along the second direction (e.g., the rightward direction). Two battery cells 210 may be provided between the adjacent first blocking members 230, and a second blocking member 231 may be provided between the two battery cells 210 that are provided between the adjacent first blocking members 230.

The second blocking member 231 may also be formed of a fire-resistant material to delay heat transfer between the battery cells 210 that face each other while the second blocking member 231 is interposed therebetween. The second blocking member 231 may also press the battery cells 210.

Pressing plates 226 and 227 may be disposed between the first side frame 221 and the battery cell 210 and the second side frame 222 and the battery cell 210, respectively.

The pressing plates 226 and 227 include a first pressing plate 226 that is provided between the first side frame 221 and the battery cell 210 that is provided on a leftmost side of the plurality of battery cells 210 and a second pressing plate 227 that is provided between the second side frame 222 and the battery cell 210 that is provided on the rightmost side end of the plurality of battery cells 210.

The first pressing plate 226 and the second pressing plate 227 may be disposed in parallel to each other and may be configured to press the plurality of battery cells 210 that are disposed between the first pressing plate 226 and the second pressing plate 227.

In this structure, when a fire occurs in the battery cell 210, high temperature gas may be discharged to an outside of the battery module 200 through the separation part 251 corresponding to the guide hole 241 provided on the upper side of the battery cell 210 in which the fire occurred. On the other hand, heat transfer to the battery cell 210 that is adjacent to the battery cell 210 in which the fire occurred may be delayed, and the separation part 251 provided on the upper side of the battery cell 210 that is adjacent to the battery cell 210 in which the fire occurred may not be separated from the cover part 252.

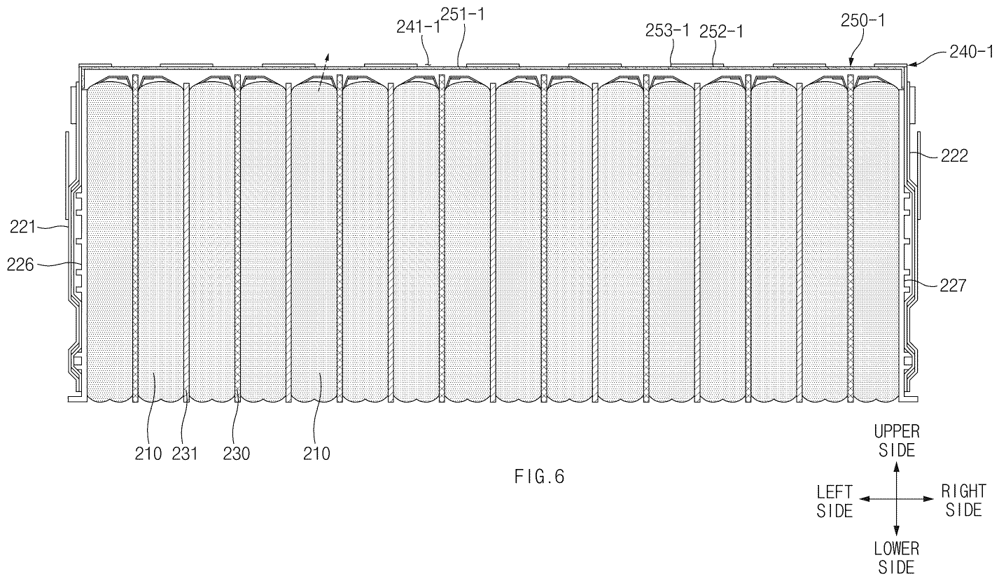

FIG. 6 is a longitudinal cross-sectional view of a battery module according to another embodiment of the present disclosure.

Referring to FIG. 6, unlike the illustration of FIG. 5, the module housing 220 (see FIG. 4) may include a module cover 250-1 that is disposed on a lower side of the module guide frame 240-1.

The module cover 250-1 may include a separation part 251-1 that is formed in an area that faces the guide hole 241-1 and is configured to be separated from the cover part 252-1 by high temperature gas pressure. The module cover 250-1 may include a perforated part 253-1 that is formed along a circumference of the separation part 251-1.

Even with this structure, when a fire occurs in the battery cell 210, the separation part 251-1 provided on the upper side of the battery cell 210 in which the fire occurred may be separated from the cover part 252-1 and high temperature gas may be discharged to an outside of the battery module 200 through the guide hole 241-1. Heat transfer to the battery cell 210 that is adjacent to the battery cell 210 in which the fire occurred may be delayed, and the separation part 251-1 provided on the upper side of the battery cell 210 that is adjacent to the battery cell 210 in which the fire occurred may not be separated from the cover part 252-1.

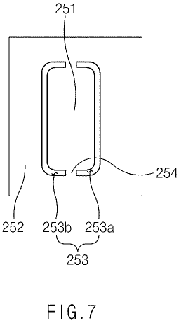

FIG. 7 is a schematic view of the module cover, in which a perforated part is formed, according to an embodiment of the present disclosure.

Referring to FIG. 7, the module cover 250 (see FIG. 5) may include a perforated part 253 that is formed along a circumference of the separation part 251. The perforated part 253 may be configured such that an upper area of the module cover 250 and a lower area of the module cover 250 are communicated with each other.

The perforated part 253 may include a first perforated part 253a and a second perforated part 253b that is formed symmetrical to the first perforated part 253a. One end of the first perforated part 253a and one end of the second perforated part 253b in a circumferential direction of the separation part 251 and an opposite end of the first perforated part 253a and an opposite end of the second perforated part 253b may be spaced apart from each other.

A connecting part 254 that is configured to connect the separation part 251 to the cover part 252 may be provided between one end of the first perforated part 253a and one end of the second perforated part 253b or between an opposite end of the first perforated part 253a and an opposite end of the second perforated part 253b.

According to the structure, the separation part 251 may be separated from the cover part 252 and high temperature gas may be discharged to an outside of the battery module 200 while the connecting part 254 is cut along the first perforated part 253a and the second perforated part 253b by a high temperature gas pressure.

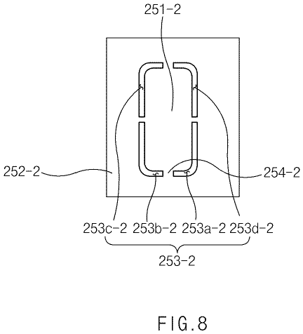

FIG. 8 is a schematic view of a module cover, in which a perforated part is formed, according to another embodiment of the present disclosure.

Referring to FIG. 8, the module cover 250 (see FIG. 5) may include a perforated part 253-2 that is formed along a circumference of the separation part 251-2. The perforated part 253-2 may be configured such that an upper area of the module cover 250 and a lower area of the module cover 250 are communicated with each other.

The perforated part 253-2 may include first to fourth perforated parts 253a-2, 253b-2, 253c-2, and 253d-2. The first to fourth perforated parts 253a-2, 253b-2, 253c-2, and 253d-2 may extend to surround the separation part 251-2 and may be spaced apart from a circumference of the separation part 251-2.

A connecting part 254-2 that connects the separation part 251-2 and the cover part 252-2 may be provided between the first to fourth perforated parts 253a-2, 253b-2, 253c-2, and 253d-2 in the circumferential direction of the separation part 251-2.

According to the structure, the separation part 251-2 may be separated from the cover part 252-2 and high temperature gas may be discharged to an outside of the battery module 200 while the connecting part 254-2 is cut along the first to fourth perforated parts 253a-2, 253b-2, 253c-2, and 253d-2 by a high temperature gas pressure.

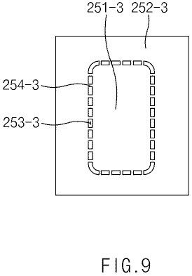

FIG. 9 is a schematic view of a module cover, in which a perforated part is formed, according to another embodiment of the present disclosure.

Referring to FIG. 9, the module cover 250 (see FIG. 5) may include a perforated part 253-3 that is configured to surround an area that faces the guide hole 241. The perforated part 253-3 may be provided along a circumference of the separation part 251-3 that is configured to be separated from the cover part 252-3.

The perforated part 253-3 of FIG. 8 may have four perforated parts 253-3 that gather to have an approximately rectangular shape and one perforated part 253-2 is provided on each side of the rectangular shape, whereas the perforated parts 253-3 of FIG. 9 gather together with the connecting part 254-3 to have an approximately rectangular shape, and two or more perforated parts 253-3 and connecting parts 254-3 may be formed on each side of the rectangular shape.

A larger number of perforated parts 253-3 may be provided than in FIG. 8 to be spaced apart from each other along a circumference of the separation part 251-3. A connecting part 254-3 may be provided between the plurality of perforated parts 253-3.

According to the structure, the separation part 251-3 may be separated from the cover part 252-3 along the connecting part 254-3 by the high temperature gas pressure, and the high temperature gas may be discharged to an outside of the battery module 200.

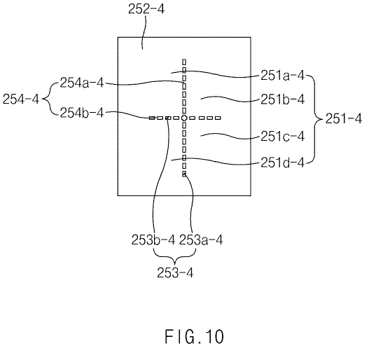

FIG. 10 is a schematic view of a module cover, in which a perforated part is formed, according to another embodiment of the present disclosure.

Referring to FIG. 10, the module cover 250 (see FIG. 5) may include a perforated part 253-4 that is provided in an area that faces the guide hole 241. The module cover 250 may include a separation part 251-4 that is separated to be cut from the cover part 252-4 by the high temperature gas pressure.

The perforated part 253-4 includes a first perforated part 253a-4 that is arranged along the first direction (e.g., the forward direction) in a lengthwise direction of the module cover 250 and a second perforated part 253b-4 that is arranged along the second direction (e.g., the rightward direction) that is a perpendicular direction to the first direction and crosses the first perforated part 253a-4 in an intermediate area of the first perforated part 253a-4.

The extension directions of the first perforated part 253a-4 and the second perforated part 253b-4 are not limited thereto, and it is sufficient as long as they extend to cross each other in intermediate areas thereof. A first connecting part 254a-4 and a second connecting part 254b-4 may be provided between the first perforated part 253a-4 and the second perforated part 253b-4.

The separation part 251-4 may be divided into first to fourth separation parts 251a-4, 251b-4, 251c-4, and 251d-4 by the first perforated part 253a-4 and the second perforated part 253b-4.

According to the structure, the first to fourth separation parts 251a-4, 251b-4, 251c-4, and 251d-4 may be separated from each other and the high temperature gas may be discharged to the outside of the battery module 200 while the connecting part 254-4 provided between the perforated parts 253a-4 and 253b-4 is cut by the high temperature gas pressure.

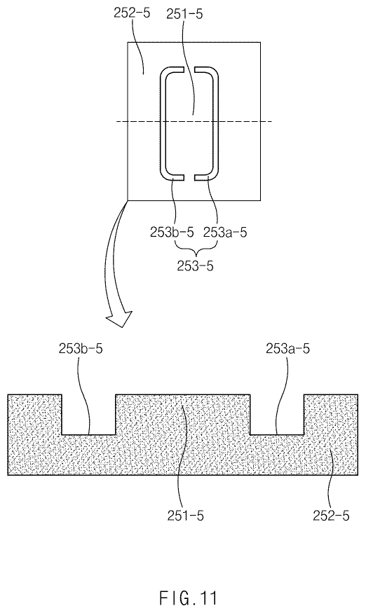

FIG. 11 is a schematic view of a module cover, in which a notch part is formed, according to another embodiment of the present disclosure.

Referring to FIG. 11, the module cover 250 (see FIG. 5) may include a notch part 253-5 that is formed in an area that faces the guide hole 241 or is formed along a periphery of the area that faces the guide hole 241.

The notch part 253-5 may be a part that has a relatively small thickness compared to the cover part 252-5. The notch part 253-5 may be provided along a circumference of the separation part 251-5.

The notch part 253-5 may include a first notch part 253a-5 and a second notch part 253b-5 that is spaced apart from the first notch part 253a-5 along a circumference of the separation part 251-5.

The first notch part 253a-5 and the second notch part 253b-5 are provided to have relatively thin thicknesses compared to the other areas of the cover part 252-5 so that the high temperature gas in an interior of the battery module 200 may be discharged to an outside of the battery module 200 while the separation part 251 is separated from the cover part 252-5.

Embodiments of the present disclosure are not limited thereto, and the notch part 253-5 may be configured to correspond to the shapes of the perforated parts 253, 253-2, 253-3, and 253-4 described above. As an example, a plurality of notch parts 253-5 may be provided to be spaced apart from each other along a circumference of the separation part 251-5.

Furthermore, in correspondence to the perforated part 253-4 illustrated in FIG. 10, the notch parts 253-5 may include first notch parts that are arranged along the first direction of the module cover 250 and second notch parts that are arranged in the second direction that crosses the first direction and cross the first notch parts in intermediate areas of the first notch parts.

The above-described shapes of the perforated parts 253, 253-2, 253-3, and 253-4 and notch parts 253-5 are not limited thereto, and it is sufficient as long as the separation parts 251, 251-2, 251-3, 251-4, and 251-5 may be easily separated from each other by the high temperature gas.

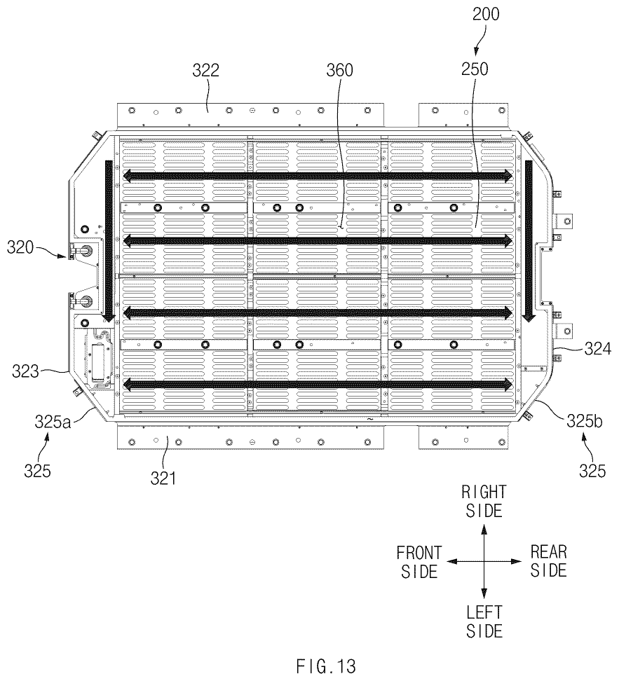

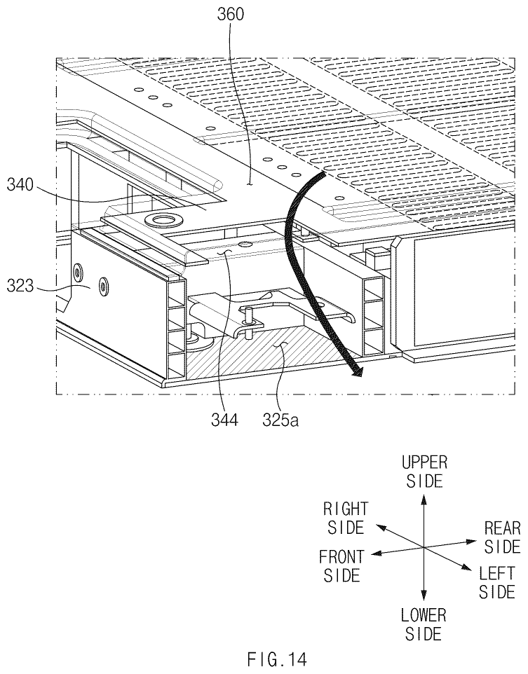

FIG. 12 is a longitudinal cross-sectional view of the battery pack according to an embodiment of the present disclosure. FIG. 13 is a schematic view illustrating a flow of a fluid vented through the venting passage according to an embodiment of the present disclosure. FIG. 14 is a schematic view illustrating a flow of a fluid discharged to an outside of the battery pack through the communication hole and the discharge hole according to an embodiment of the present disclosure.

Hereinafter, referring to FIGS. 12 to 14, a process of venting high temperature gas caused by a fire that occurs in a battery cell 210 will be described in detail.

Referring to FIGS. 12 to 14, the battery module 200 may be accommodated in an interior of the battery pack housing 300. A cooling water channel part 311 that is provided in the base plate 310 may be provided on a lower side of the battery module 200. The venting frame 340 and the pack cover 350 may be provided on an upper side of the battery module 200.

When a fire occurs in the battery cell 210 accommodated in the interior of the battery module 200, the high temperature gas generated in the battery cell 210 may be disposed to an upper side of the battery module 200 through a passage that is formed as the separation part 251 is separated from the guide hole 241 provided on an upper side of the battery cell 210 and the module cover 250.

The battery cell 210 in which the fire occurred may have a relatively higher temperature than those of the other battery cells 210, and heat transfer from the battery cell 210 having the higher temperature to the other battery cells may be prevented by the first and second blocking members 230 and 231.

Thereafter, the high temperature gas may flow through the venting hole 341 and the venting passage 360 in the first direction (e.g., the forward direction) that is the lengthwise direction of the venting passage 360 or an opposite direction to the first direction (e.g., the rearward direction).

The venting passage 360 may be formed between the venting hole 341 of the venting frame 340 and the cover guide part 351 of the pack cover 350. A fire-resistant member 370 may be attached to a lower surface of the cover guide part 351. According to the structure in which the fire-resistant member 370 is attached to a lower surface of the cover guide part 351, the temperature of the cover guide part 351 may be prevented from rising due to the high temperature gas that flows through the venting passage 360 whereby the pack cover 350 may be prevented from being damaged.

The high temperature gas may be vented along the venting passage 360 in the first direction of the battery pack housing 300 or in an opposite direction to the first direction. The battery cell 210 of the battery module 200 other than the battery module 200 in which a fire occurred in the process of venting high temperature gas along the venting passage 360 may be covered and protected by the module cover 250.

The high temperature gas vented in the first direction (e.g., the forward direction) or in the opposite direction to the first direction (e.g., the rearward direction) may be discharged to the outside of the battery pack housing 300 through the first discharge hole 325a or the second discharge hole 325b.

The first discharge hole 325a and the second discharge hole 325b may be communicated with the venting passage 360 and may be defined by the side member 320. In more detail, the first discharge hole 325a may be formed adjacent to one end portion of the battery pack housing 300 in the first direction, and the second discharge hole 325b may be formed adjacent to an opposite end portion of the battery pack housing 300 in the first direction.

The first discharge hole 325a and the second discharge hole 325b may be formed at one end portion in the second direction while being formed at one end portion of the battery pack housing 300 in the first direction and an opposite end portion in the first direction.

Meanwhile, the venting frame 340 may be formed on an upper side of the discharge hole 325 that is adjacent to the discharge hole 325 and may define a communication hole 344 that is communicated with the venting passage 360 and the discharge hole 325.

That is, the communication hole 344 may be formed in the one end portion and the opposite end portion of the venting frame 340 in the first direction, and a pair of communication holes 344 may be provided in an area that is one end portion of the venting frame 340 in the second direction.

The venting passage 360 may be communicated with the first discharge hole 325a and the second discharge hole 325b by the communication holes 344.

Meanwhile, when a fire occurs in the battery cell 210, particles resulting from the fire may flow together with the high temperature gas, and the other parts of the electric vehicle may be damaged when the particles are discharged to an outside of the battery pack housing 300, and thus, it is necessary to prevent this.

To achieve this, the battery pack 100 (see FIG. 1) may further include a mesh member (not illustrated) that is formed in the communication hole 344 or the discharge hole 325.

According to this technology, because the fluid generated in the battery module may be guided to the outside of the battery pack, a thermal runaway in the battery module may be prevented and heat transfer between the battery cells may be delayed.

Furthermore, according to this technology, because only the fluid generated in the battery module may be discharged to an outside of the battery pack and the particles of the battery module may be prevented from being discharged to the outside of the battery pack, the safety of the vehicle may be improved.

In addition, according to this technology, because the perforated part or the notch part may be formed in the module cover of the battery module, the upper side of the battery module may be covered in a normal state of the battery module and, at the same time, the fluid generated in the battery module may be guided to the outside of the battery module only when a fire occurs in the battery module whereby the safety may be improved.

In addition, various effects that may be directly or indirectly recognized through the present disclosure may be provided.

The above description is a simple exemplary description of the technical spirits of the present disclosure, and an ordinary person in the art, to which the present disclosure pertains, may make various corrections and modifications without departing from the essential characteristics of the present disclosure.

Therefore, the embodiments disclosed in the present disclosure are not for limiting the technical spirits of the present disclosure but for describing them, and the scope of the technical spirits of the present disclosure is not limited by the embodiments. The protection scope of the present disclosure should be construed by the following claims, and all the technical spirits in the equivalent range should be construed as being included in the scope of the present disclosure.

What is claimed is:

1. A battery pack comprising:
a battery module; and
a battery pack housing covering the battery module, the battery pack housing comprising:
a venting frame disposed on an upper side of the battery module and including a venting hole configured to discharge a fluid generated in the battery module; and
a pack cover disposed on an upper side of the venting frame and communicated with the venting hole to include a venting passage extending horizontally together with the venting frame.

2. The battery pack of claim 1, wherein:
the venting hole is provided in plural and the venting holes are spaced apart in a first direction being a lengthwise direction of the venting frame and a second direction being a vertical direction;
the venting frame comprises a venting connector provided between the venting holes; and
the pack cover comprises a cover coupling part disposed on an upper side of the venting connector and coupled to the venting connector.

3. The battery pack of claim 2, wherein the pack cover comprises a cover guide part disposed on an upper side of the venting hole and extending in the first direction to guide the fluid in the first direction through the venting passage.

4. The battery pack of claim 3, wherein the cover coupling part protrudes downward toward the venting connector farther than the cover guide part.

5. The battery pack of claim 2, wherein:
the battery module is provided in plural and the battery modules are spaced apart from each other in the second direction; and
the venting connector and the cover coupling part are disposed between two adjacent battery modules when viewed from a top view.

6. The battery pack of claim 1, wherein the battery module comprises:
a plurality of battery cells;
a module guide frame disposed on an upper side of the battery cells and comprising a guide hole configured to guide the fluid generated in any one battery cell of the battery cells to an upper side of the battery module; and
a module cover disposed on a side of the module guide frame in an upward/downward direction, the module cover comprising a notch part disposed in an area facing the guide hole or configured to surround the area facing the guide hole to have a relatively small thickness.

7. The battery pack of claim 6, wherein the module cover further comprises:
a cover part disposed on the side of the module guide frame in the upward/downward direction and covering the upper side of the battery cells; and
a separation part disposed in the area facing the guide hole and configured to be separated from the cover part by a pressure of the fluid generated in the any one battery cell of the battery cells, wherein the notch part is disposed along a circumference of the separation part.

8. The battery pack of claim 6, wherein the notch part comprises:
a first notch part arranged along a first direction of the module cover; and
a second notch part arranged along a second direction of the module cover crossing the first direction and crossing the first notch part in an intermediate area of the first notch part.

9. A battery pack comprising:
a battery module; and
a battery pack housing covering the battery module, the battery pack housing comprising:
a venting frame disposed on an upper side of the battery module and including a venting hole configured to discharge a fluid generated in the battery module;
a pack cover disposed on an upper side of the venting frame and communicated with the venting hole to include a venting passage extending horizontally together with the venting frame;
a base plate configured to support the battery module; and
a side member supported by the base plate and extending along a circumference of the base plate, the side member defining a discharge hole communicated with the venting passage.

10. The battery pack of claim 9, wherein the discharge hole is disposed adjacent to one end portion of the battery pack housing in a lengthwise direction thereof.

11. The battery pack of claim 9, wherein the venting frame comprises a communication hole communicating the venting passage and the discharge hole.

12. The battery pack of claim 11, wherein the communication hole is disposed adjacent to the discharge hole on an upper side of the discharge hole.

13. The battery pack of claim 12, further comprising a mesh member disposed in the communication hole or the discharge hole.

14. The battery pack of claim 11, wherein the communication hole is disposed in a first area that is both one end portion of the venting frame in a first direction, which is a lengthwise direction thereof, and one end portion of the venting frame in a second direction, which is a perpendicular direction to the first direction.

15. The battery pack of claim 14, wherein the venting frame further comprises a venting cover part disposed in a second area that is both the one end portion of the venting frame in the first direction and an opposite end portion of the venting frame in the second direction, the venting cover part dividing an upper area and a lower area of the venting frame.

16. A battery pack comprising:
a battery module comprising:
a plurality of battery cells;
a module guide frame disposed on the battery cells and comprising a guide hole configured to guide a fluid generated from any battery cell of the battery cells to an upper side of the battery module; and
a module cover disposed on a side of the module guide frame in an upward/downward direction, the module cover comprising a perforated part disposed in an area facing the guide hole or disposed along a periphery of the area facing the guide hole; and
a battery pack housing covering the battery module, the battery pack housing comprising:
a venting frame disposed on the upper side of the battery module and including a venting hole configured to discharge the fluid generated in the battery module; and
a pack cover disposed on an upper side of the venting frame and communicated with the venting hole to include a venting passage extending horizontally together with the venting frame.

17. The battery pack of claim 16, wherein the module cover further comprises:
a cover part covering an upper side of the battery cells; and
a separation part disposed in the area facing the guide hole and configured to be separated from the cover part by a pressure of the fluid generated in the any one battery cell of the battery cells.

18. The battery pack of claim 17, wherein the perforated part is disposed along a circumference of the separation part.

19. The battery pack of claim 18, wherein the perforated part comprises:
a first perforated part; and
a second perforated part spaced apart from the first perforated part.

20. The battery pack of claim 18, wherein the perforated part comprises:
a first perforated part arranged along a first direction of the module cover; and
a second perforated part arranged along a second direction of the module cover crossing the first direction and crossing the first perforated part in an intermediate area of the first perforated part.
